(19) United States
(12) Patent Application Publication
(10) Pub. No.: US 2018/0348023 A1
(43) Pub. Date: Dec. 6, 2018

(54) Sensor Calibration Based On Environmental Factors

(71) Applicant: Google LLC, Mountain View, CA (US)

(72) Inventors: Greg Joseph Klein, Mountain View, CA (US); Daniel Aden, Mountain View, CA (US); Arshan Poursohi, Mountain View, CA (US)

(21) Appl. No.: 14/735,093

(22) Filed: Jun. 9, 2015

(51) Int. Cl. G01D 18/00; G01K 15/00

(52) U.S. Cl. CPC G01D 18/00; G01K 15/005

(57) ABSTRACT

Implementations disclosed herein may relate to sensor calibration based on environmental factors. An example method may involve a computing system receiving an indication of a current environment state of an area from environment state sensors. While the environment sensors indicate that the area is in a particular environment state, the system may receive data corresponding to an aspect of the area from a first sensor as well as data from additional sensors. Using the received data, the system may compare the data from the first sensor with a compilation of the data from the additional sensors to determine an accuracy metric that represents an accuracy of the first sensor when the first sensor operates in the area during the particular environment state. The system may repeat the process to determine accuracy metrics to calibrate sensors in the area depending on the environment state of the area.

### BACKGROUND

Physical spaces may be used for retail, manufacturing, assembly, distribution, and office spaces, among others. Over time, the manner in which these physical spaces are designed and operated is becoming more intelligent, more efficient, and more intuitive. As technology becomes increasingly prevalent in numerous aspects of modern life, the use of technology to enhance these physical spaces becomes apparent. Therefore, a demand for such systems has helped open up a field of innovation in sensing techniques, data processing, as well as software and user interface design.

### SUMMARY

Example implementations of the present disclosure may relate to sensor calibration based on environmental factors. Sensors often provide a computing system with information about an area, such as objection location information and general information corresponding to activity in the area. In some instances, one or more sensors configured to operate within an area may provide more or less accurate information depending on one or more current environment conditions of the area. As such, while an area is in a particular environment state, a computing system may determine an accuracy metric for a sensor operating in an area that indicates an accuracy level of the sensor for the particular environment state. The computing system may also use the determine accuracy metric to determine calibration parameters (e.g., one or more data offsets) for increasing the accuracy of the sensor depending on the environment on the area. By extension, in some instances, the computing system may also determine calibration parameters for one or more sensors of an area for a variety of environment states that may exist within the area.

By way of an example implementation, a computing system associated with a sensor system serving one or more areas may utilize sensor data provided by one or more environment state sensors to determine the current environment state of one or more areas. While the environment state sensors indicate that a given area in in a particular environment state, the computing system may receive sensor data from a first sensor undergoing calibration analysis and sensor data from one or more additional sensors. In particular, the sensor data received from the various sensors may correspond to a given aspect of the area, such as a location of an object or information relating to tactile or sound information of the area, etc. Using the received sensor data, the computing system may execute one or more comparisons or similar tests between the sensor data provided by the first sensor and the sensor data provided by the one or more additional sensors to determine an accuracy metric of the first sensor that indicates an accuracy level of the first sensor in the area while the area is in the particular environment. The computing system may repeat this process or similar processes to determine accuracy metrics for one or more sensors in the area while the area is in various environment states. This may enable the computing system to calibrate multiple sensors within an area depending on environment conditions and/or other factors that may impact the operation of one or more sensors. Other example implementations for determining calibration metrics for sensors based on environment conditions are described herein.

In one aspect, a method is provided. The method may include receiving, at a computing system from one or more environment state sensors, an indication of a current environment state of an area. The method may also include, while the one or more environment state sensors indicate that the area is in a particular environment state, receiving, at the computing system from a first sensor, sensor data indicative of an aspect of the area, and while the area is in the particular environment state, receiving, at the computing system from a plurality of additional sensors, sensor data indicative of the aspect of the area. The method may further include performing a comparison between the set of sensor data received from the first sensor and a compilation of the sensor data received from the plurality of additional sensors, and based on the comparison, determining, at the computing system, an accuracy metric indicating an accuracy of the first sensor when the first sensor operates in the area while the area is in the particular environment state.

In another aspect, a system is provided. The system may include one or more processors, and a non-transitory computer-readable medium, configured to store instructions, that when executed by the one or more processors, cause the computing system to perform functions. The functions may include receiving, from one or more environment state sensors, an indication of a current environment state of an area. The functions may further include, while the one or more environment state sensors indicate that the area is in a particular environment state, receiving, from a first sensor, sensor data indicative of an aspect of the area, and while the area is in the particular environment state, receiving, from a plurality of additional sensors, sensor data indicative of the aspect of the area. The functions may also include performing a comparison between the set of sensor data received from the first sensor and a compilation of the sensor data received from the plurality of additional sensors, and based on the comparison, determining an accuracy metric of the first sensor when the first sensor operates in the area while the area is in the particular environment state.

In yet another aspect, a non-transitory computer-readable medium configured to store instructions, that when executed by one or more processors, cause a computing system to perform functions. The functions may include receiving, from one or more environment state sensors, an indication of a current environment state of an area. The functions may further include, while the one or more environment state sensors indicate that the area is in a particular environment state, receiving, from a first sensor, sensor data indicative of an aspect of the area, and while the area is in the particular environment state, receiving, from a plurality of additional sensors, sensor data indicative of the aspect of the area. The functions may also include performing a comparison between the set of sensor data received from the first sensor and a compilation of the sensor data received from the plurality of additional sensors, and based on the comparison, determining an accuracy metric of the first sensor when the first sensor operates in the area while the area is in the particular environment state.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1 depicts a configuration of a system for sensor calibration based on environmental factors, in accordance with an example implementation.

FIG. 2 depicts a physical space, in accordance with an example implementation.

FIG. 3 illustrates a flowchart depicting an example implementation of sensor calibration based on environmental factors.

FIG. 4A depicts an example implementation of a computing system determining accuracy metrics for sensors operating in a physical space during a particular environment state.

FIG. 4B depicts the example implementation of FIG. 4A while the physical space is in a different environment state.

FIG. 5 depicts a representation of a physical space, in accordance with an example implementation.

FIG. 6 depicts a heat map, in accordance with an example implementation.

FIG. 7 depicts another heat map, in accordance with an example implementation.

### DETAILED DESCRIPTION

In the following detailed description, reference is made to the accompanying figures, which form a part hereof. In the figures, similar symbols typically identify similar components, unless context dictates otherwise. The illustrative implementations described in the detailed description, figures, and claims are not meant to be limiting. Other implementations may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### I. Overview

Example implementations of the present disclosure relate to sensor calibration based on environmental factors. A physical space may be divided into different coverage areas that include sensors configured to serve and provide information regarding aspects of each area, such as information relating to location of objects, sounds, tactile information, etc. During operation, each sensor measuring a given area in the physical space may capture and provide sensor data to a computing system associated with the sensor system. In some cases, the accuracy level of each sensor may depend on the environment state of the area. In particular, some environment conditions may impact the operation and/or accuracy of certain sensors.

In some instances, the type of sensor or other parameters of the sensor (e.g., position of the sensor in the area) may also impact the accuracy of the sensor as one or more environment conditions of the area change. For instance, a range-based sensor may operate more accurately in an area when the area has a low ambient light level. By contrast, a camera sensor may operate more accurately when the area has a high ambient light level. Similarly, other types of factors may produce sensor data influenced by other environment conditions.

In some instances, to determine the impact of the environment state of an area on one or more sensors operating in the area, a computing system associated with the sensor system may determine respective accuracy metrics for the sensor(s) in the area that indicate accuracy levels of the sensor(s) when the given area is in a particular environment state. In some example implementations, in order to determine the respective accuracy metrics for sensors operating in a given area, the computing system may utilize incoming sensor data provided from one or more environment state sensors configured to determine an environment state of the given area. For instance, a computing system may receive temperature information from a thermometer, ambient light information from a light sensor, and an indication of humidity and network activity in the area from other sensors, among other possibilities. Furthermore, in some instances, the computing system may combine the different environment conditions to determine an overall environment.

While the environment sensors indicate that the area is in a particular environment state, the computing system may receive sensor data from a first sensor undergoing calibration analysis and one or more additional sensors operating in the area. The sensor data may correspond to an aspect of the area, such as a location of an object. Using the received sensor data, the computing system may compare the data received from the first sensor with a compilation of data received from the one or more additional sensors to determine an accuracy metric for the first sensor that indicates an accuracy level of operation of the first sensor while the area in in the particular environment state.

The computing system may repeat this process or similar processes to determine accuracy metrics for one or more sensors operating in the given area while the area is in a variety of environment states. This way, the computing system may determine information that indicates how different environment conditions influence sensors operating in different areas. As such, the computing system may develop statistics that illustrate the strength of sensor coverage in different areas and possibly enable the computing system or a user to predict how one or more sensors may operate in a given area during other environment states.

By way of an example implementation, a sensor system operating in one or more respective areas may include a camera and a range-based sensor configured to detect the location of objects in one or more of the areas. In some instances, the sensor system may include more or less sensors, including more than one camera and/or range-based sensors as well as one or more environment state sensors. While the one or more environment state sensors indicate that a given area is in a particular environment state, the computing system may receive sensor data from the camera and the range-based sensor that indicates the location of an object in the given area. Based on the sensor data received, the computing system may compare the location information from the camera and the location information from the range-based sensor to determine an accuracy metric of the camera and/or range-based sensor that indicates the accuracy level of the respective sensor while the area is in the particular environment state. In some instances, the computing system may utilize additional information from other sensors during a given comparison for determining an accuracy metric.

Using the process or similar processes described above, the computing system may determine an accuracy metric for the camera when the area is in a high ambient light state and another accuracy metric for the camera when the area is in a low ambient light state. Likewise, the computing system may also determine accuracy metrics for the camera during different levels of ambient light states as well. Additionally, the computing system may also gather and store all the determined accuracy metrics to develop information about the overall operation of the camera as well as the strength of coverage in the area during different environment states. Similarly, the computing system may determine accuracy metrics that predict the accuracy of one or more sensors at different times throughout the course of a day.

In some example implementations, the computing system may develop one or more heat maps and/or other type of dynamic graphical interfaces that can display the strength of coverage of sensor(s) in one or more areas based on determined accuracy metrics influenced by changes in the environment. For instance, the heat map may show the coverage area for one or more areas based on a range of temperatures for the areas. Similarly, a determined heat map may display coverage strength of sensors for an area based on the time of day, the humidity level, the amount of network traffic, the ambient light level, or other environment conditions that may impact the operation of one or more sensors within the area.

### II. Example Systems

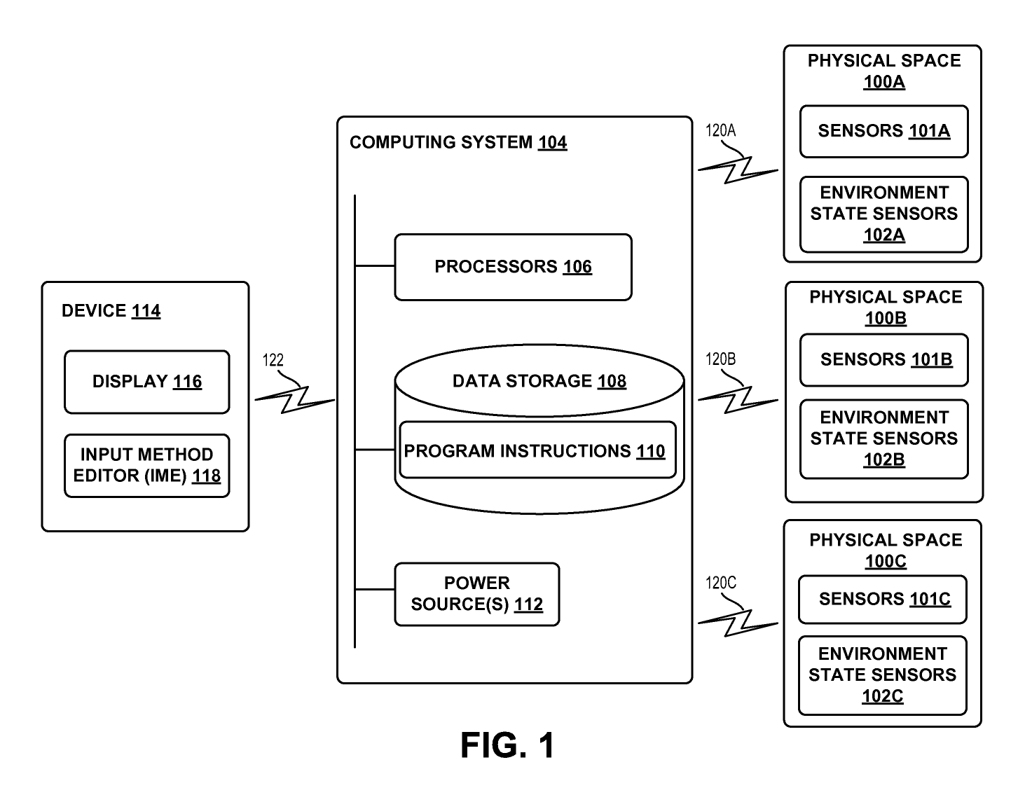

Referring now to the figures, FIG. 1 shows an example arrangement including one or more physical spaces 100A-100C each having one or more sensors 101A-101C and one or more environment state sensors 102A-102C, respectively. A physical space may define a portion of an environment in which people, objects, and/or machines may be located. The physical space may take on a two-dimensional or a three-dimensional form and may be used for various purposes. For instance, the physical space may be used as a retail space where the sale of goods and/or services is carried out between individuals (or businesses) and consumers. While various aspects of the disclosure are discussed below in the context of a general space, example implementations are not limited to general spaces and may extend to a variety of other physical spaces such as retail spaces, manufacturing facilities, distribution facilities, office spaces, shopping centers, festival grounds, and/or airports, among other examples. Additionally, while three physical spaces 100A-100C are shown in FIG. 1, example implementations may be carried out in the context of a single physical space or a plurality of physical spaces.

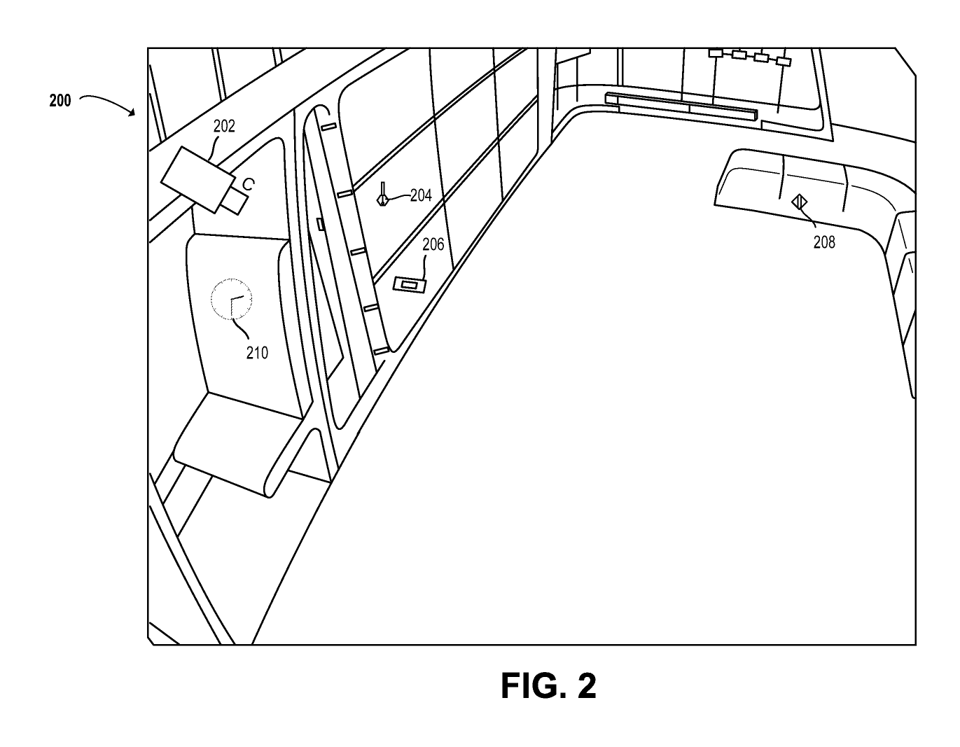

For context purposes, FIG. 2 depicts an example physical space 200, embodied as a general location. Physical space 200 may have a variety objects positioned throughout the physical space, such as displays (not visible) as well as devices 322A-322D, among others. Various sensors (e.g., sensors 302 and 304) may be positioned throughout the physical space to facilitate the collection of certain information (e.g., aspects of the areas), such as the location and movement of objects and actors throughout the physical space. This type of information may be provided to managers or actors of the physical space to help make decisions about how to improve or maintain the physical space, or for other reasons. Similarly, environment state sensors (e.g., sensor 306, sensor 308, and sensor 310) may also be positioned throughout the physical space to determine environmental conditions of areas of the physical space, such as a temperature, ambient light level, humidity, or other information that may indicate the environment state of the areas.

As mentioned, each physical space may include one or more sensors 101A-101C and one or more environment state sensors 102A-102C. In some examples, one or more of the sensor(s) 101A-101C may be temporarily provided within the physical spaces (e.g., at the set-up phase of a new physical space) in order to engage in the calibration of one or more sensors based on environment conditions described herein. Accordingly, the sensor(s) 101A-101C may be relatively more sophisticated (and in some cases, relatively more expensive) than the environment state sensors 102A-102C. Example sensors 101A-101C may include but are not limited to certain motion-capture (Mocap) sensors, or Velodyne LiDAR sensors, generic force sensors, proximity sensors, motion sensors (e.g., an inertial measurement units (IMU), gyroscopes, and/or accelerometers), load sensors, position sensors, thermal imaging sensors, facial recognition sensors, depth sensors (e.g., RGB-D, laser, structured-light, and/or a time-of-flight camera), point cloud sensors, ultrasonic range sensors, infrared sensors, Global Positioning System (GPS) receivers, sonar, optical sensors, biosensors, Radio Frequency identification (RFID) systems, Near Field Communication (NFC) chip, wireless sensors, compasses, smoke sensors, light sensors, radio sensors, microphones, speakers, radars, touch sensors (e.g., capacitive sensors), cameras (e.g., color cameras, grayscale cameras, and/or infrared cameras), and/or range sensors (e.g., ultrasonic and/or infrared), among others. Example environment state sensors 102A-102C may include but are not limited to thermometers, light sensors, microphones, humidity sensors, network traffic sensors, and cameras, among others.

Additionally, the sensors and environment state sensors may be positioned within or in the vicinity of the physical space, among other possible locations. Further, an example implementation may also use sensors incorporated within existing devices such as mobile phones, laptops, and/or tablets. These devices may be in possession of people located in the physical space such as consumers and/or employees within a retail space. Additionally or alternatively, these devices may be items on display such as in a retail space used for sale of consumer electronics, for example. Yet further, each of physical spaces 100A-100C may include the same combination of sensors or may each include different combinations of sensors.

FIG. 1 also depicts a computing system 104 that may receive data from the sensors 102A-102C positioned in the physical spaces 100A-100C. In particular, the sensors 102A-102C may provide sensor data to computing system by way of communication links 120A-120C, respectively. Communication links 120A-120C may include wired links and/or wireless links (e.g., using various wireless transmitters and receivers). A wired link may include, for example, a parallel bus or a serial bus such as a Universal Serial Bus (USB). A wireless link may include, for example, Bluetooth, IEEE 802.11 (IEEE 802.11 may refer to IEEE 802.11-2007, IEEE 802.11n-2009, or any other IEEE 802.11 revision), Cellular (such as GSM, GPRS, CDMA, UMTS, EV-DO, WiMAX, HSPDA, or LTE), or Zigbee, among other possibilities. Furthermore, multiple wired and/or wireless protocols may be used, such as “3G” or “4G” data connectivity using a cellular communication protocol (e.g., CDMA, GSM, or WiMAX, as well as for “Wi-Fi” connectivity using 802.11).

In other examples, the arrangement may include access points through which the sensors 101A-101C and 102A-102C and/or computing system 104 may communicate with a cloud server. Access points may take various forms such as the form of a wireless access point (WAP) or wireless router. Further, if a connection is made using a cellular air-interface protocol, such as a CDMA or GSM protocol, an access point may be a base station in a cellular network that provides Internet connectivity by way of the cellular network. Other examples are also possible.

Computing system 104 is shown to include one or more processors 106, data storage 108, program instructions 110, and power source(s) 112. Note that the computing system 104 is shown for illustration purposes only as computing system 104, but may include additional components and/or have one or more components removed without departing from the scope of the disclosure. Further, note that the various components of computing system 104 may be arranged and connected in any manner.

Each processor, from the one or more processors 106, may be a general-purpose processor or a special purpose processor (e.g., digital signal processors, application specific integrated circuits, etc.). The processors 106 can be configured to execute computer-readable program instructions 110 that are stored in the data storage 108 and are executable to provide the functionality of the computing system 104 described herein. For instance, the program instructions 110 may be executable to provide for processing of sensor data received from sensors 101A-101C and 102A-102C.

The data storage 108 may include or take the form of one or more computer-readable storage media that can be read or accessed by the one or more processors 106. The one or more computer-readable storage media can include volatile and/or non-volatile storage components, such as optical, magnetic, organic or other memory or disc storage, which can be integrated in whole or in part with the one or more processors 106. In some implementations, the data storage 108 can be implemented using a single physical device (e.g., one optical, magnetic, organic or other memory or disc storage unit), while in other implementations, the data storage 108 can be implemented using two or more physical devices. Further, in addition to the computer-readable program instructions 110, the data storage 108 may include additional data such as diagnostic data, among other possibilities. Further, the computing system 104 may also include one or more power source(s) 112 configured to supply power to various components of the computing system 104. Any type of power source may be used such as, for example, a battery.

FIG. 1 further depicts a device 114 that is shown to include a display 116 and an Input Method Editor (IME) 118. The device 114 may take the form of a desktop computer, a laptop, a tablet, a wearable computing device, and/or a mobile phone, among other possibilities. Note that the device 114 is shown for illustration purposes only as device 114 may include additional components and/or have one or more components removed without departing from the scope of the disclosure. Additional components may include processors, data storage, program instructions, and/or power sources, among others (e.g., all (or some) of which may take the same or similar form to components of computing system 104). Further, note that the various components of device 114 may be arranged and connected in any manner.

The device 114 may serve as an interface for interacting with statistical representations and/or heat maps. For instance, the device 114 may enable a user or computing system (e.g., robotic device) to provide inputs to the computing system 104 to adjust parameters of the heat maps or other types of statistical representations.

In some cases, an example arrangement may not include a separate device 114. That is, various features/components of device 114 and various features/components of computing system 104 can be incorporated within a single system. However, in the arrangement shown in FIG. 1, device 114 may receive data from and/or transmit data to computing system 104 by way of communication link 122. Communication link 122 may take on the same or a similar form to communication links 120A-120C as described above.

Display 116 may take on any form and may be arranged to project images and/or graphics to a user of device 114. In an example arrangement, a projector within device 114 may be configured to project various projections of images and/or graphics onto a surface of a display 116. The display 116 may include: an opaque or a transparent (or semi-transparent) matrix display, such as an electroluminescent display or a liquid crystal display, one or more waveguides for delivering an image to the user's eyes, or other optical elements capable of delivering an image to the user. A corresponding display driver may be disposed within the device 114 for driving such a matrix display. Other arrangements may also be possible for display 116. As such, display 116 may show a graphical user interface (GUI) that may provide an application through which the user may interact with the systems disclosed herein.

Additionally, the device 114 may receive user-input (e.g., from the user of the device 114) by way of IME 118. In particular, the IME 118 may allow for interaction with the GUI such as for scrolling, providing text, and/or selecting various features of the application, among other possible interactions. The IME 118 may take on various forms. In one example, the IME 118 may be a pointing device such as a computing mouse used for control of the GUI. However, if display 116 is a touch screen display, touch-input can be received (e.g., such as using a finger or a stylus) that allows for control of the GUI. In another example, IME 118 may be a text IME such as a keyboard that provides for selection of numbers, characters and/or symbols to be displayed by way of the GUI. For instance, in the arrangement where display 116 is a touch screen display, portions the display 116 may show the IME 118. Thus, touch-input on the portion of the display 116 including the IME 118 may result in user-input such as selection of specific numbers, characters, and/or symbols to be shown on the GUI by way of display 116. In yet another example, the IME 118 may be a voice IME that receives audio input, such as from a user by way of a microphone of the device 114, that is then interpretable using one of various speech recognition techniques into one or more characters than may be shown by way of display 116. Other examples may also be possible.

### III. Example Sensor Calibration Based on Environment Factors

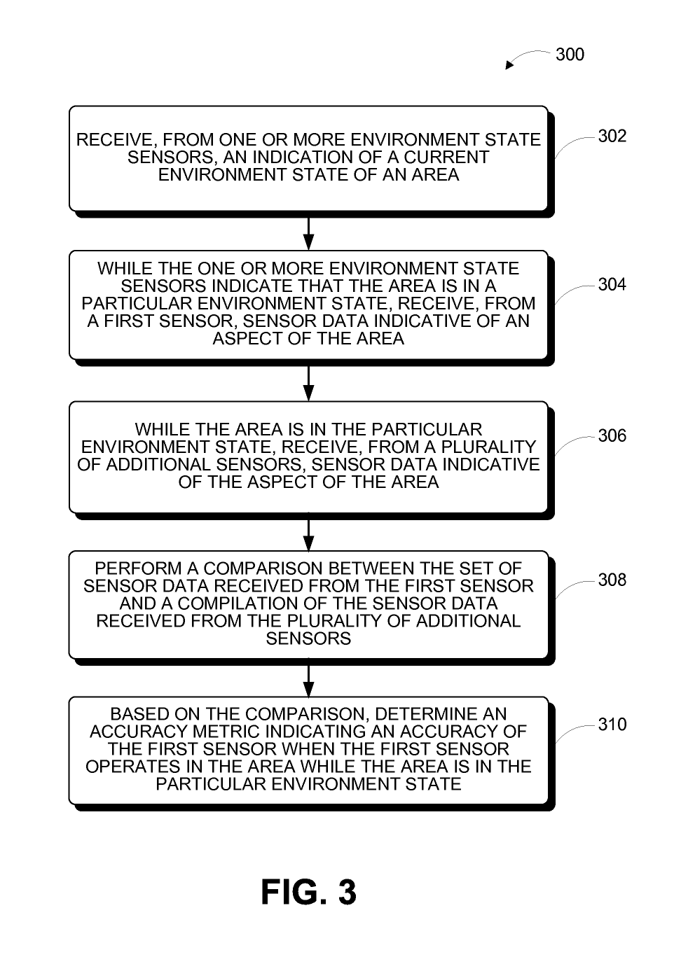

FIG. 3 is a flowchart of example method 300 for calibrating sensors based on environmental factors. The example method 300 may include one or more operations, functions, or actions, as depicted by one or more of blocks 302, 304, 306, 308, 310, each of which may be carried out by any of the systems described by way of FIGS. 1 and 2; however, other configurations could be used.

Furthermore, those skilled in the art will understand that the flowchart described herein illustrate functionality and operation of certain implementations of the present disclosure. In this regard, each block of the flow diagram may represent a module, a segment, or a portion of program code, which includes one or more instructions executable by a processor (e.g., the one or more processors 106) for implementing specific logical functions or steps in the process. The program code may be stored on any type of computer readable medium, for example, such as a storage device including a disk or hard drive (e.g., data storage 108). In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

Turning to FIG. 3, method 300 includes receiving, from one or more environment state sensors, an indication of a current environment state of an area. As indicated herein, a computing system (e.g., computing system 104) may communicate with a sensor system receiving data from various points (i.e., areas) of a physical space. The sensor system may include one or more environment state sensors configured to obtain information relating to environment conditions of the areas. For instance, computing system 104 may communicate with environment state sensors 102A positioned in an area or areas of physical space 100A, environment state sensors 102B positioned in an area or areas of physical space 100B, and/or environment state sensors 102C positioned in an area or areas of physical space 100C.

Example environment state sensors may include, but are not limited to thermometers, light sensors, humidity sensors, network activity sensors, motion sensors, among others. An example sensor system may have multiple types of environment state sensors configured to provide information relating to environment conditions of an area to a computing system to use for determining an environment state of the area. By way of an example implementation, an environment state sensor (e.g., environment state sensors 102A) positioned in a physical space (e.g., physical space 100A) may provide an indication of an environment state of the physical space or a portion of the physical space (e.g., area). For illustration purposes, the environment state sensors may capture and provide information regarding environment conditions of an area on a periodic, continuous, or per-request basis.

Using data obtained from one or more environment state sensors, the computing system may determine the current environment state for areas. In some cases, the computing system may determine an environment state of an area based on accumulating information relating to any number of environment conditions of the area, such as the humidity, the number of actors, ambient light level, temperature, and network traffic, among other possible environment conditions.

In some instances, the computing system may determine that different areas of a physical space have variations in their respective environment states. For instance, computing system 104 may determine that the environment state of physical space 100A differs from the environment state of physical space 100B.

Moreover, the computing system may also associate periods of time with environment states of areas. This may be particular useful when an area tends to rotate between the same couple environment states depending on the time of day. As such, the computing system may determine patterns that indicate the typical environment states for an area depending on the time of day or other factors (e.g., number of actors within the area). To illustrate, the computing system may determine that an area is usually a given temperature (e.g., 75 degrees Fahrenheit) during the morning (e.g., 8 a.m. to 11 a.m.) and different temperatures during other points of the day. The computing system may determine similar patterns for other environment conditions of areas, such as the typical amount of network traffic or amounts of ambient light that are typical during various time periods. In some cases, the computing may further associate environment states based on day of the week or other possible patterns that impact changes of the environment in the areas.

At block 304, method 300 includes receiving sensor data indicative of an aspect of the area from a first sensor while the one or more environment state sensors indicate that the area is in a particular environment state. As indicated above, the computing system (e.g., computing system 104) may receive data from environment state sensors to determine environment states for one or more areas at any given time. The incoming sensor data from environment state sensors enable the computing system to determine current environment states for one or more areas in real-time. In addition to environment state information, the computing system may also communicate with other sensors operating within the areas configured to provide information relating to aspects of the areas (e.g., object location information). For instance, the computing system 104 may communicate with sensors 101A positioned in physical space 100A, sensors 101B positioned in physical space 100B, and/or sensors 101C positioned in physical space 100C.

As indicated above, the computing system may receive sensor data from a first sensor operating in a given area. The first sensor may correspond to any type of sensor configured to provide data to the computing device. For example, the first sensor may correspond to certain motion-capture (Mocap) sensors, or Velodyne LiDAR sensors, generic force sensors, proximity sensors, motion sensors (e.g., an IMU, gyroscopes, and/or accelerometers), load sensors, position sensors, thermal imaging sensors, facial recognition sensors, depth sensors (e.g., RGB-D, laser, structured-light, and/or a time-of-flight camera), point cloud sensors, ultrasonic range sensors, infrared sensors, GPS receivers, sonar, optical sensors, biosensors, RFID systems, NFC chip, wireless sensors, compasses, smoke sensors, light sensors, radio sensors, microphones, speakers, radars, touch sensors (e.g., capacitive sensors), cameras (e.g., color cameras, grayscale cameras, and/or infrared cameras), and/or range sensors (e.g., ultrasonic and/or infrared), among others.

The computing system may receive sensor data from the first sensor that corresponds to an aspect of the given area in the particular environment state. As the sensor data is being received from the first sensor, the computing system may associate that data with the current environment state of the area of the first sensor as indicated by one or more environment state sensors. For instance, the computing system may associate images received from a camera with the current ambient light level of the area of the camera. Similarly, the computing system may associate a general environment state of the area with the sensor data being received from the first sensor (e.g., associating location information received from a directional microphone with the current noise level, temperature, and humidity of the area). The computing system may use one or more particular environment conditions or groupings of the environment conditions (e.g., environment state) for association purposes with incoming data received from the first sensor.

The sensor data received from the first sensor may correspond to any aspect of an area. For instance, the sensor data may indicate visual data besides location of an object or objects, or different types of aspects of the environment, such as sounds, forces detected by tactile sensors, etc. In some cases, the computing system may receive sensor data from a sensor indicating a location of a subject within the area. In the context of this application, a subject is any object located in the physical space that is able to be detected by a sensor. In some implementations, a subject is an inanimate object, such as a computing device, an article of merchandise, or piece of machinery located in the physical space, among other examples. However, in other implementations, a subject is an animate object, such as a human being, animal, or robotic device that is able to move about the physical space, among other examples.

In some examples, the indication of the particular location of the subject is received by a computing system (e.g., computing system 104) and in the form of computer-readable data packets specifying coordinates of the particular location. In some examples, these coordinates may be framed from an arbitrary point of reference, such as the center of the physical space or one corner of the physical space. In other examples, the particular location may be in the form of an address, and/or a list of characters representing a name (e.g., a name of a department within a retail space), among other possibilities. Further, the indication of the particular location may be received in the form of anonymized data streams. That is, primary-sensor data representing information related to people located within the physical space may represent people as discrete entities. In this manner, the sensor data may not provide any information related to an individual identity of a person, thereby maintaining privacy of the individual.

In an example implementation, the first sensor may correspond to a sensor positioned a robotic device. As such, the robotic device may travel from one or more areas using the sensor to provide the computing system with sensor data indicative of the current area of the robotic device. In some instances, the computing system may communicate with the robotic device and provide instructions for the robotic device to travel to a particular area or perform one or more operations.

Continuing at block 306, method 300 includes the computing system receiving sensor data indicative of the aspect of the area from a plurality of additional sensors while the area is in the particular environment state. Similar to receiving sensor data indicative of an aspect of an area from a first sensor while the area is in a particular environment state, the computing system may also receive sensor data from one or more additional sensors that correspond to the same aspect of the area while the area is in the same environment state. This enables the computing system to execute a comparison between sensor data provided by the one or more additional sensors and the first sensor to determine how the environment state may impact the operation and/or accuracy of the first sensor.

By way of example, the computing system may receive object location information from a range-based sensor as well as from other sensors, such as cameras and directional microphones, while the area is in a particular environment state. The computing system may receive the sensor data from the first sensor and additional sensors during the same time period or, alternatively, during different periods of time when the environment state sensors indicate that the area is in the same particular environment state. In some instances, the additional sensors may correspond to one or more sensor types that differ from the type of sensor of the first sensor.

In an example implementation, the computing system may receive sensor data from a first sensor corresponding to an aspect during a first time period when the area is in a particular environment state and also receive sensor data from additional sensors corresponding to the same aspect during a second time period when the environment state sensors indicate that the area is in the same particular environment state. Despite receiving the sensor data from the first sensor and the additional sensors during different time periods, the computing system may compare the sensor data since the sensor data corresponds to times when the area was in the same particular environment state.

In some example implementations, the computing system may actively select sensors for using data to compare with data received from the first sensor. For instance, the computing system may select one or more additional sensors to use sensor data based on the location of the first sensor. The computing system may select to use data from sensors positioned nearby a robotic device that has the first sensor, for example. The computing system may also use other sensors positioned on a robotic device in the case that the first sensor is operating on the robotic device or associated with the robotic device. This way, the computing system may execute a comparison of sensors located on the robotic device while the robotic device is within one or more environment states. The robotic device may travel and enable the sensors to operate under different environment conditions for calibration purposes, for example.

At block 308, method 300 includes performing a comparison between the set of sensor data received from the first sensor and a compilation of the sensor data received from the plurality of additional sensors. Using the sensor data acquired from the first sensor and the additional sensors while the area is in a particular environment state, the computing system may execute a comparison to determine differences between the received data. In particular, the computing system may identify any differences that the data from the first sensor includes relative to the data from the other sensors. In some instances, the comparison may yield more accurate results when data from the first sensor is compared with sensor data from a large number of sensors and/or recently calibrated sensors since these instances are likely going to provide reliable data for comparison purposes. Similarly, a comparison may provide accurate results when data from the first sensor is compared to one or more sensors known to be effective (e.g., produce accurate data) in certain environment states.

The compilation of sensor data may correspond to a general collection of the sensor data provided from additional sensors or a weighted average of the sensor data from the one or more additional sensors, for example. Similarly, the compilation of the sensor data corresponds to a mathematical average of sensor data received from additional sensors. Other examples of configuring the compilation of data may exist.

Additionally, the computing system may compile sensor data from any number of sensors. For example, the computing system may utilize data provided from a combination of five sensors to determine a compilation of sensor data. In some instances, the computing system may select data from particular sensors to use in the comparison despite receiving sensor data indicative of the same aspect from other sensors as well.

In some example implementations, the computing system may perform comparisons between incoming sensor data received from a first sensor and other sensors in a continuous manner. In other words, the computing system may constantly compare incoming sensor data to detect variations between the sensor data provided by a first sensor compared to the sensor data received from other sensors in the area that correspond to the same aspect as the data from the first sensor. For instance, the computing system may compare location information of an object as indicated by a first sensor with sensor data depicting the location of the object from other available sensors.

In another example implementation, the computing system may perform a number of comparisons to compare the data from the first sensor to data received from other sensors. For instance, in an example where the first sensor corresponds to a camera that is providing object location information, the computing system may first compare the object location information of the camera with object location information received from a range-based sensor. Next, the computing system may perform another comparison that involves comparing the object location information of the camera with object location information received from directional-microphones. Likewise, the computing system may perform additional and/or repetitive comparisons.

At block 310, method 300 includes the computing system determining, based on the comparison, an accuracy metric indicating an accuracy of the first sensor when the first sensor operates in the area while the area is in the particular environment state. By performing one or more comparisons, the computing system may determine an accuracy metric that indicates an accuracy of the operation of the first sensor while the area is in the particular environment state. In some instances, the determined accuracy metric may indicate the accuracy of the first sensor in the particular environment state relative to the sensor data received from the other sensors as determined based on the one or more comparisons. For instance, the comparison may show that the accuracy of the sensor data of the first sensor is nearly identical (i.e., substantially similar) to the results provided in the additional sensors. In such a case, the accuracy metric may indicate that the first sensor is operating accurately, which may signal that the current environment state of the area is not impacting the operation of the first sensor. In some implementations, the accuracy metric is an expected maximum amount of error for measurements received from the sensor while the environment is in a particular state.

In another example, the comparison may show that the sensor data provided by the first sensor differs substantially from the compilation of sensor data provided by the other sensors. In this scenario, the substantial differences shown during the comparison may signal that the first sensor is operating less accurately in the area due to one or more environment conditions of the environment state of the area and/or other possible reasons (e.g., mechanical failures, lack of power). Consequently, in some cases, the computing system may perform an additional comparison to check the results, acquire more sensor data from the first sensor and the other sensors for a further comparison, or perform other confirmation results. In other cases, the computing system may use and/or store the determined accuracy metric indicating operation of the first sensor associated with the area in the particular environment state.

In some cases, the computing system may use a determined accuracy metric to further determine an offset for calibrating the sensor data from the first sensor when the area is in the current environment state of the area that impacts the accuracy of the data. The computing system may determine the offset based on the comparison to adjust data received from the first sensor to align with the data provided from the other sensors while the area is in the particular environment state. By extension, the computing system may store the accuracy metric as well as the determined offset to use in situations when the area is in the particular environment state associated with the accuracy metric.

In an example implementation, the computing system may determine the accuracy metric to represent the accuracy of the first sensor operating in the particular environment state relative to the operation of the first sensor in the area during other environment states. In some cases, the determined accuracy metric may indicate when the accuracy of the first sensor increases or decreases due to environment conditions of the area. For example, the computing system may determine accuracy metrics for a thermal sensor that indicates that the thermal sensor operates more accurately when the area has a colder temperature compared to when the area has a warmer temperature. The computing system may repeat method 300 or other processes to an extent that enables the computing system to determine what particular degrees an area should to maximize the accuracy of the thermal camera as well as what temperatures cause the thermal camera to provide completely inaccurate results. For instance, the computing system may determine a thermal camera in an area having a temperature below a predefined temperature operates likely operates effectively (e.g., providing more accurate information). The predefined temperature may correspond to a temperature that serves as a benchmark for indicating whether a thermal sensor or other type of sensor may operate accurately, for example.

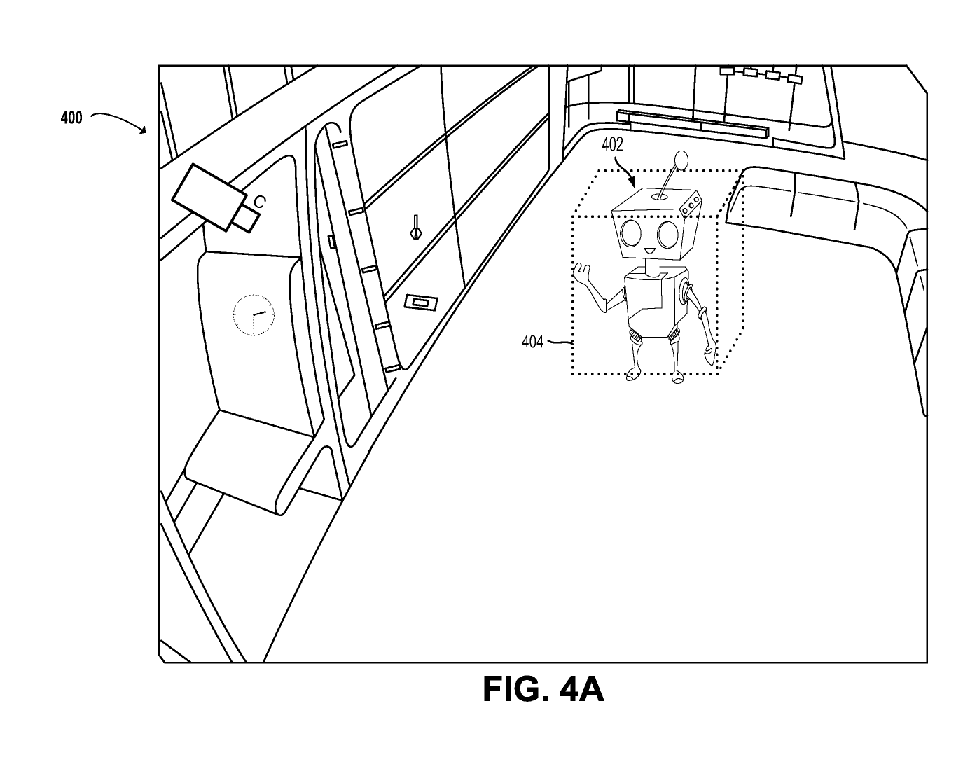

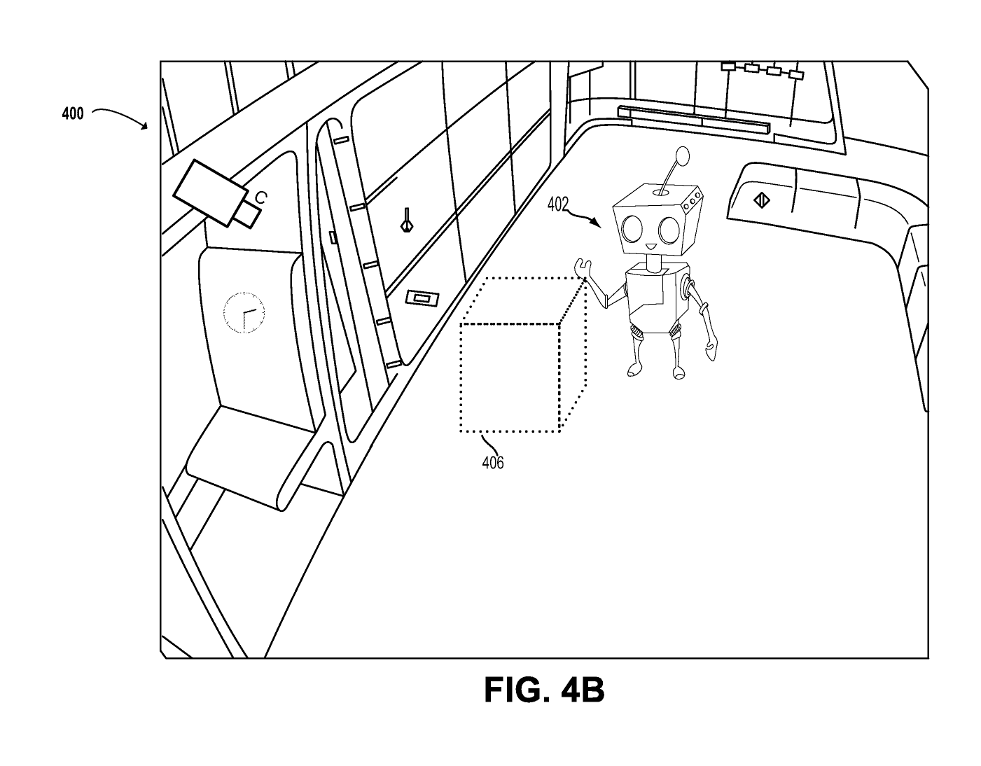

FIG. 4A and FIG. 4B depict example implementations of a computing system determining accuracy metrics for sensors operating in a physical space during different environment states. The example implementation involves a computing system (e.g., computing system 104) measuring accuracy metrics for one or more sensors operating in an area to determine the accuracy associated with incoming sensor data received from the sensors. Through executing one or more iterations of method 300 or similar processes, the computing system may determine if certain sensors operate less accurate in some situations. For instance, the computing system may identify particular sensors that often perform less accurately when some environment conditions exist in the area.

The example implementation shown in FIGS. 4A and 4B depicts physical space 400 that corresponds to the physical space 200 shown in FIG. 2. Other example implementations may involve different sensors operating in other possible physical spaces.

Referring to FIG. 4A, the example implementation shows a variety of sensors operating in physical space 400. The sensors may provide a computing system with information relating to aspects of the physical space 400, such as object, sound, and motion detection, for example. In the example shown in FIGS. 4A-4B, the sensors are shown providing object location information detecting a robotic device 402 in the physical space 400 to a computing system for processing. In some instances, the sensors may provide sensor data to multiple computing systems.

As indicated, one or more sensors are shown providing location data indicating a position of robotic device 402 in the area to a computing system. For instance, in one possible implementation, the computing system may receive data (e.g., location data 404) from a first sensor (e.g., a camera) that indicates the location of robotic device 402 as represented by the three-dimensional cube positioned around robotic device 402. In other examples, the first sensor may correspond to another type of sensor. In addition to the first sensor, the computing system may also receive location data indicating the location of the robotic device 402 from one or more other sensors (e.g., range-based sensors) to use to compare with the location data (404) from the first sensor.

As shown in FIG. 4A, the computing system may determine that the first sensor has an accuracy metric that indicates that the first sensor is providing accurate location data 404 corresponding to the actual location of the robotic device 402 since the 3D cube is shown positioned around the actual location of the robotic 402. As a result, the computing system may determine that the first sensor is providing accurate information. This may indicate that the first sensor is not impacted by the current environment state of the area and/or that other operation errors are not impacting the performance of the first sensor. Based on determining that the first sensor is providing accurate location information for the robotic device 402 relative to other sensors operating in the physical space 400, the computing system may allow the first sensor to continue to operate without determining any calibration parameters (e.g., a data offset) for the sensor data associated with the first sensor. In addition, the computing system may also add the determined accuracy metric to memory, a statistical representation, and/or a heat map, for example. This may enable the computing system to determine that the first sensor operates accurately during other times when the physical space 400 is in the current environment condition.

FIG. 4B further illustrates an extension of the example implementation shown in FIG. 4A. In particular, FIG. 4B shows an example of the computing system determining that sensor data indicating the location of the robotic device 402 in physical 400 received from a first sensor is less accurate. Similar to FIG. 4A, the computing system may receive sensor data indicating the location of the robotic device 402 from a first sensor (i.e., a sensor undergoing testing) and other sensors to use for a comparison. Based on performing a comparison between the sensor data indicating the location of the robotic device 402, the computing system may determine another accuracy metric for the first sensor that indicates the accuracy of the location data received from the first sensor.

As shown in FIG. 4B, the computing system may determine that the first sensor is operating less accurately since the location data 406 (represented by the 3D cube) is not positioned around the actual location of the robotic device. As such, the accuracy metric may indicate that the computing system may need to calibrate the first sensor data. In some instances, using other determined accuracy metrics for the first sensor, the computing system may determine that the particular environment state or certain environment conditions are impacting the operation of the first sensor resulting in the less accurate data. As a result, the computing system may determine a data offset and/or other calibration parameters for the first sensor. Additionally, the computing system may also use the determined accuracy metric to update stored statistics or a heat map to indicate that the first sensor operates less accurately when the physical space 400 is in the environment conditions of FIG. 4B compared to the when the physical space 400 is in the environment conditions of FIG. 4A.

In yet another example implementation, the computing system may perform method 300 to determine that a camera operating in an area provides more accurate data when operating in an area having a certain range of ambient light. In particular, the determined accuracy metrics for the camera may indicate that the camera operates accurately when the area contains an average amount of ambient light compared to a low level of ambient light or a high level of ambient light. The computing system may use a predetermined amount of ambient light for comparison reasons. The predetermined amount (e.g., an average amount) may be based on incoming sensor data provided by an ambient light sensor. In some instances, the computing system may determine that another camera operate better in a different range of ambient light, which may be due to the position of the camera or other factors.

In a further example implementation, the computing system may use directional microphones as the first sensor to determine accuracy of data incoming from the directional microphones. In particular, the computing system may compare subject location information from the directional microphones to other subject location information from additional sensors to determine accuracy metrics for the directional microphones over a variety of environment states. As a result, the computing system may determine that the directional microphones operate more accurately in certain environment conditions (e.g., when the area has less noise). The computing system may further determine that the accuracy of the directional microphones depend on other environment conditions, such as the humidity or the number of actors in the area, for example.

A computing system may execute method 300 or similar processes to determine accuracy metrics to use for calibrating sensors to minimize effects of environment conditions in one or more areas. For instance, the computing system may determine an offset for the first sensor based on determining that the first sensor is less accurate operating in an area while the area in a particular environment state. The computing system may provide instructions to one or more systems to physically calibrate the first sensor based on determined metrics. In some instances, the computing system may adjust incoming sensor data based on the determined offset. This way, the computing system may store a variety of calibration parameters for one or more sensors and adjust the sensor data based on changes in the environment state of the area. By extension, the computing system may adjust the coverage area to limit less accuracy coverage depending on the environment state of the area.

In some examples, the computing system may develop one or more statistical representations based on determined accuracy metrics for one or more sensors in an area when the area is in a variety of environment states. The statistical representation may exist in various forms and may include information relating to the accuracy levels for sensor(s) operating in areas while the areas are in different environment states. For instance, the computing system may develop statistics based on operation of a camera in a given area while the area is in a variety of environment states. This way, the computing system may use the statistics to identify certain conditions that enable the camera to operate accurately. The computing system may provide the statistical representation to other computing devices and/or may provide the representation in the form of an interactive display, for example. In addition, the computing system may use the statistics to determine coverage strengths of sensors in areas depending on the environment state of the area.

Additionally, the computing system may determine a pattern or patterns that indicate the impact of environment states of an area for one or more sensors operating in that area. In some cases, the computing system may use determined spatial patterns to identify sensors that more impacted by certain environment conditions than others. For instance, the computing system may determine that directional microphones work more accurately in quiet environments compared to noisy environments. The computing system may use the determined patterns to predict how accurately a certain sensor or group of sensors may work in a new environment state. As such, the determined patterns may show how different environment conditions impact the operation of a certain sensor, which may depend on the type of sensor, the position of the sensor, and/or the power required by the sensor, among other possibilities. Similarly, the computing system may determine temporal patterns that indicate how the coverage strengths of sensors in one or more areas may change depending on a time of day.

In some cases, the computing system may use determined patterns to predict the coverage strength of sensors within a given area while the area is in one or more environment states. The computing system may use the determined patterns to provide instructions to a system or systems to modify the area to reduce the impact of the environment state on the sensors. For instance, the computing system may adjust temperatures, the amount of light, and/or amount of power provided to an area based on a determined pattern.

Additionally, in some example implementations, the computing system may develop a graphical heat map that indicates the strength of coverage by sensors in different areas associated with one or more physical spaces. Similar to the determined patterns, the graphical heat map may visually display the coverage strength for one or more areas and expressly show how a particular environment state or environment condition(s) impact the strength of coverage of sensors in the areas. As such, the graphical heat map may be configured to show changes in the coverage strength of areas as the environment state of the areas change.

In some cases, the computing system may configure the heat map in a way that enables the heat map to actively represent the coverage strengths of sensors in areas based on input received from another computing device and/or a user through an interface. For example, the computing system may receive an input requesting the heat map to show the coverage strengths of the areas when the area are in a particular environment state (e.g., above 80 degrees Fahrenheit). The heat map may illustrate the coverage strengths based on previously determined accuracy metrics and/or predictions developed based on the determined patterns that correspond to the accuracy metrics. The computing system may cause the heat map to illustrate the operation of all the sensors in a given area or to only show one or more selected types of sensors, for example.

Furthermore, the computing system may modify the graphical heat map to further include information received from one or more newly determined accuracy metrics of a sensor (e.g., first sensor). In a periodic or continuous modification process, the computing system may update the graphical heat map to reflect the strength of coverage in multiple areas when the areas are in different environment states. For instance, the computing system may update the heat map upon determining the accuracy levels of one or more sensors while the area is in a new environment state. Additionally, the computing system may update the heat map to reflect possible changes in determined accuracy metrics for sensors since operation of sensors may change over time due to use.

By way of an example implementation of method 300, the computing system may receive an indication that an area is in a high ambient light environment state from one or more light sensors. While the area is in the high ambient light state, the computing system may further receive sensor data from a camera (i.e., the first sensor) and from multiple range-based sensors that all correspond to location information of an object in the area. To determine an accuracy metric for the camera operating in the high ambient light environment state, the computing system may compare the object location as indicated by the camera with the object location as indicated by the multiple range-based sensors. As a result, the computing system may determine the accuracy metric to indicate the accuracy of the camera when the camera operates in area during high ambient light state. The computing system can repeat this process to determine multiple accuracy metrics for the camera with each determined accuracy metric depicting the operation of the camera when the area is in different environment states (e.g., low ambient light and middle ambient light). Through multiple iterations, the computing system may develop information that portrays operation of sensors in various environment conditions and/or different contexts.

In another example implementation of method 300, the computing system may receive an indication from one or more environment states sensors that an area is at above normal temperature and high noise level. While the area is in the determined environment state, the computing system may perform a comparison of data received from a thermal camera and others sensors. This comparison may yield results that indicate that thermal camera less accurate compared to other sensors when the thermal camera operates in an area having an above normal temperature. By performing multiple iterations of method 300 or similar process when the area is in other environment states (e.g., lower temperatures), the computing system may further determine additional accuracy metrics that indicate that thermal camera works more accurately in lower temperatures. As such, the computing system may cause a heat map to show that coverage strength of thermal cameras is higher when the areas are in lower temperatures compared to higher temperatures. Furthermore, in some instances, the computing system may use determined accuracy metrics to determine that some conditions do not impact the first sensor (e.g., noise does not impact the accuracy of a thermal camera) and/or impact the operation of the first sensor to a lesser degree than other environment conditions.

In the prior example implementation, the computing system may also determine using method 300 or similar processes that directional microphones produce more accurate results when an area has less noise. As such, the computing system may also cause the heat map to display information indicating the accuracy of directional microphones for one or more areas when the areas are in a variety of environment states (e.g., noisy or quiet).

By way of another example implementation, while one or more environment state sensors indicate that an area is in a particular environment state, the computing system may perform method 300 or similar processes in one or more iterations to identify one or more sensors operating in the area that are producing less accurate information due to the environment state. For instance, the area may include 10 sensors and the computing system may identify that 2 sensors require calibration in some form (e.g., determining an offset for incoming sensor data) while the area is in the particular environment state.

In some instances, the computing system may further provide instructions to one or more systems associated with an area or areas to modify one or more aspects of the area(s) to adjust the environment state to improve operation of sensors within those areas. For instance, the computing system may provide instructions to a heating/cooling system to adjust the temperature of one or more areas and/or instructions to a window system to close or open portions of the window (e.g., blinds) to adjust the ambient light level. Other example instructions may relate to closing or opening windows, adjusting positions of objects, and increasing or decreasing power applied to one or more objects or systems within the areas, among others. In some cases, the computing system may adjust the environment state of an area to improve the operation a particular sensor within the given area.

In an example implementation, the computing system may receive an indication that a given area is in a particular environment state with a humidity level above a predefined humidity level. For instance, a humidity sensor may provide data indicating that the humidity level is above a certain amount of humidity (e.g., predefined humidity level). The computing system may determine the predefined humidity level based on a number of iterations that indicate a level of humidity that starts to impact operation of one or more sensors. In some instances, the computing system may have multiple predefined humidity levels that depend on the type of sensor since different sensors may operate less accurately in varying amounts of humidity in a given area.

In another example implementation, the computing system may receive an indication from one or more network activity sensors that indicate that an area has a level of network activity above a predetermined threshold of network activity. In particular, the predetermined threshold of network activity may correspond to a quantity of network activity (e.g., a number of devices communicating on the network or available bandwidth) that starts to impact the operation of a given sensor and/or the ability of the given sensor to communicate (i.e., provide) the sensor data to the computing system. In situations where the measured network activity exceeds the predetermined threshold of network activity, the computing system may determine accuracy metrics that indicate a particular sensor or multiple sensors may be impacted (e.g., providing sensor data) by the amount of the network activity.

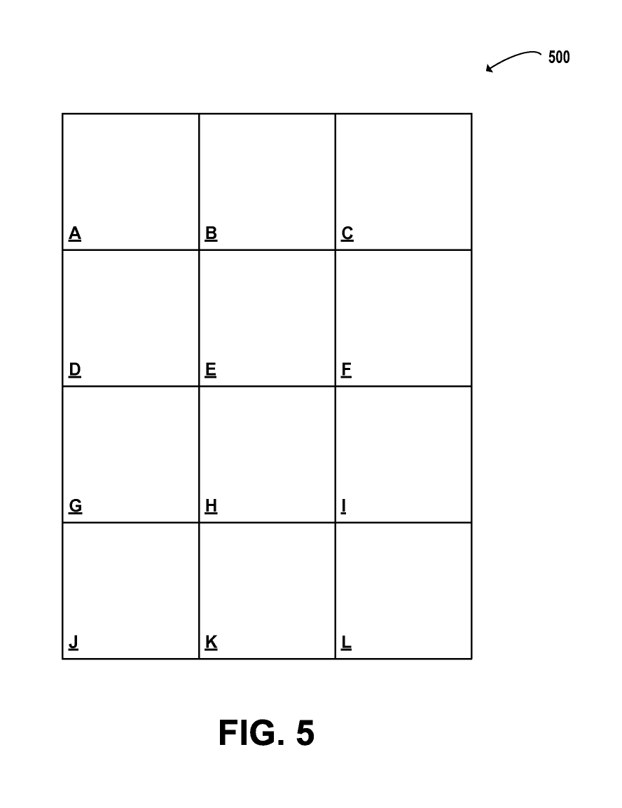

FIG. 5 depicts a representation of a physical space, in accordance with an example implementation. The physical space 500 is shown having areas A, B, C, D, E, F, G, and H that may each include sensors configured to communicate with a computing system (e.g., computing system 104). In some instances, the various areas may be connected in a physical manner creating the physical space 500 overall. For instance, the areas may correspond to a retail space. In other examples, the areas may be physically separate areas or a combination of connected and non-contiguous areas. Additionally, the sizes of the areas are shown as uniform in size, but may vary in other examples. The areas may contain any number of sensors, including one or more environment sensors. For instance, area A may include 6 sensors and area B may include 2 different sensors. Other example physical spaces having one or more areas with sensors are possible.

To further illustrate, the various areas may include environment sensors configured to provide information indicating the current environment state of the areas, respectively. Likewise, an area may also include other types of sensors, such as range-based sensors or cameras configured to provide information to the computing system relating to one or more aspects of the area (e.g., location of objects within the area). Other example areas and sensor layouts are possible within implementations of methods and systems described herein.

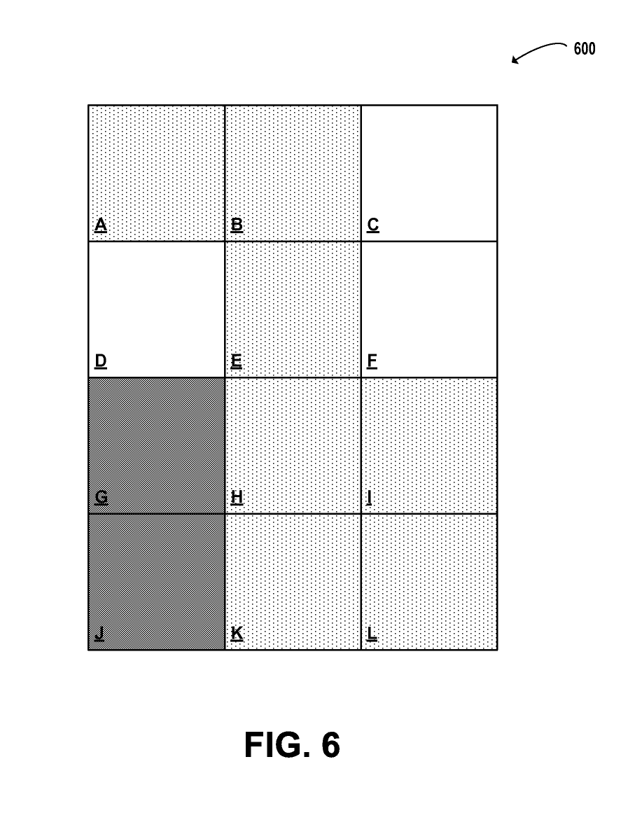

FIG. 6 depicts a heat map, in accordance with an example implementation. As previously indicated herein, a computing system (e.g., computing system 104) may develop a heat map (e.g., heat map 600) to represent information, such as the current coverage strengths of sensors operating within certain areas. The computing system may produce and modify the heat map 600 based on incoming sensor data received from sensors positioned in the areas of physical space 500 shown in FIG. 5. In other examples, the heat map 600 may correspond to other areas.

The computing device may develop heat map 600 based on determined accuracy metrics that indicate the current accuracy of particular sensors since environment conditions may impact the actual accuracy of the data provided by the sensors within the areas. As such, the computing system may periodically or continuously modify the heat map 600 to reflect changes in coverage strength that may result from newly determined accuracy metrics for sensors. This way, the heat map 600 may accurately portray the coverage strengths enabled by sensors at any given period of time.

In some implementations, a computing system, user, and/or other computing device (e.g., a robotic device) may utilize the information presented by the heat map 500 for various reasons. For instance, a user may identify the areas that have the strongest current coverage strength for accurate information and also identify the areas that may be lacking coverage strength from sensors. In some cases, areas with less coverage strength may indicate that the environment state or particular environment conditions are impacting the operation of one or more sensors within the area.

As shown in FIG. 6, the heat map 600 displays visual indications that represent the ability of given sensors in an area to provide accurate data during the current environment state of the area. The heat map 600 may show or partially show the influence environment conditions in the different areas under sensor measuring may impact the operation of the sensors. In some cases, the heat map 600 may also show other information, such as decreases in coverage of sensors due to sensor malfunctions, loss of power, physical obstruction, or some other reason that may prevent or limit a sensor from operating efficiently and effectively.

In the example implementation shown in FIG. 6, the heat map 600 shows illustrate coverage strengths provided by sensors positioned in areas A, B, C, D, E, F, G, H, I, J, K, and L. The heat map 600 is divided into sectors that correspond to the areas, respectively, but may have other configurations within examples. For instance, the heat map 600 may represent coverage strengths of sensors in a numerical format that differentiates between strength levels on a numerical basis. Each sector includes a shade that indicates the coverage strengths of the given area in the example implementation. In other implementations of heat maps, the heat map 600 may provide other information, such as indications when sensors are not working properly or the overall power consumption of sensors in each area, for example. In the present implementation, the degree of shading may indicate the degree of coverage by the sensors in a given area. For example, the darkest shading may indicate the strongest coverage while the lightest shading indicating the weakest coverage by the sensors.

In the example heat map 600 depicted in FIG. 6, areas G and J are relatively dark, whereas areas A, B, E, H, I, K, and L are medium-dark, and areas C, D, and F are relatively light. First, as indicated above, this may indicate that the strength of coverage by the sensors is stronger (e.g., providing more accurate information) in areas G and J than the other areas. In particular, the heat map 600 may indicate that sensors operating in areas G and J are producing accurate data or that the environment states of areas G and J are favorable for obtaining sensor data indicative of aspects in the area.

Second, the heat map 600 may indicate that areas C, D, and F have the least amount of coverage by sensors. As such, the shade of areas C, D, and F in the heat map 600 may indicate that the particular environment states of the respective areas impact the accuracy of one or more sensors of areas C, D, and F. Based on the example heat map 600, the computing system may receive more accurate information from sensors operating in areas G and J relative to the information received from areas C, D, and F. The heat map 600 may also indicate that a lower amount of sensors are operating properly in areas C, D, and F based on the shading within the heat map 600 for those areas, respectively.

In some examples, heat map 600 is provided to a system operator who may analyze the heat map to make decisions about the physical space. For instance, based on heat map 600, the operator may determine to provision additional sensors (e.g., new sensors or robotic sensors) at or near areas C, D, and F in order to increase the accuracy of coverage in those areas. The computing system may provide instructions to one or more robotic devices or other types of devices to add sensors to a given area based on the coverage strengths indicated in the heat map 600.

Additionally or alternatively, the operator may decide to move any sensors at or near areas G or J as they may not be providing any additional benefit to those sectors. And still additionally or alternatively, the operator may determine to place merchandise near high-accuracy areas (e.g., sectors G and J) because the computing system may more accurately determine when subjects are near the merchandise or other information within the area. Other determinations may be made based on heat maps as well.

In an additional example implementation, the heat map 600 may correspond to the strength of coverage in the areas based on a time of day. For instance the heat map 600 may correspond to the strength of coverage in the areas during a time period (e.g., 1 p.m.-2 p.m.). This may involve displaying an average strength of coverage determined based on multiple days of acquired sensor data and determined accuracy metrics for multiple sensors. As such, the heat map 600 may illustrate changes in coverage of sensors in the areas during different periods of the day. Furthermore, the heat map 600 also includes dynamic capabilities that enable the heat map 600 to display information upon requests from a user or another computing device. The heat map 600 may reflect illustrate cover strength of sensors in areas in a variety of environment states, for example.

A computing system or another device may use the heat map 600 to determine adjustments for one or more areas. For instance, a robotic device may use the heat map 600 to identify regions with less coverage by sensors and travel to that area to use robotic sensors to improve the coverage. Likewise, the robotic device may use the heat map 600 to perform other operations. The computing system may provide instructions to one or more systems associated with the areas to adjust areas to improve sensor coverage strength. In some cases, the computing system may provide instructions to systems to make adjustments to the areas to improve the environment state for sensors operating in the area (e.g., adjust the network traffic, temperature, and humidity levels). Likewise, a user or the computing system may use the information provided within the heat map 600 to predict the accuracy of sensors in uncertain environment conditions, for example. Other uses of the heat map 600 may exist in examples.

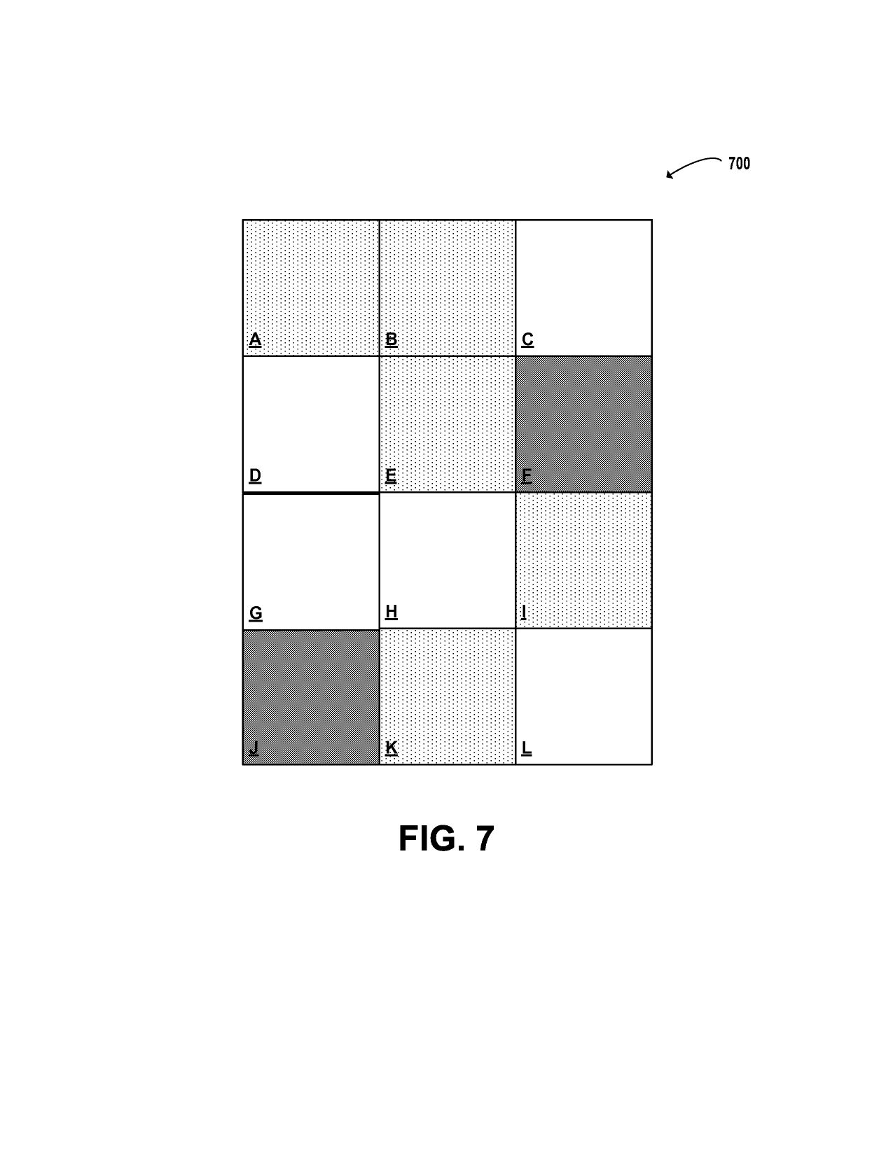

FIG. 7 depicts another heat map, in accordance with an example implementation. The heat map 700 may correspond to heat map 600 shown in FIG. 6, but further illustrate updates in the coverage strengths of sensors operating in areas A, B, C, D, E, F, G, H, I, J, K, and L. The changes within the heat map 700 may result from newly determined accuracy metrics for respective sensors in the areas or may also illustrate the changes in the strength of coverage of the areas due to the heat map 700 corresponding to changes in the environment states of one or more areas. In some cases, the heat map 700 may display information relating to requests for a certain time of day or show the sensors coverage if one or more areas are in a particular environment state. As such, the heat map 700 may be used to predict possible coverage strengths.

In some cases, the heat map 700 may be configured to show the coverage strengths within areas for a particular type of sensor. For instance, the heat map 700 may display information showing the coverage enabled by thermal cameras in the areas. Since areas F and J are darker than the other areas, this may indicate that areas F and J are in environment states with colder temperatures since thermal cameras tend to operate more accurately in colder temperatures. Similarly, the darker shading show in the heat map may indicate that areas F and J have other favorable environment conditions that enable accurate thermal camera operations. Likewise, areas A, B, E, I, and K are lighter than areas F and J in the heat map 700, which may indicate that these areas may have warmer temperatures since thermal cameras produce less accurate results in warmer temperatures. The lighter shade of areas A, B, E, I, and K may indicate that the coverage strength of the thermal cameras is less than in the darker areas on the heat map 700. The heat map 700 may be configured to show strengths of coverage for other types of sensors in other examples.

### IV. Conclusion

The present disclosure is not to be limited in terms of the particular implementations described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example implementations described herein and in the figures are not meant to be limiting. Other implementations can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The particular arrangements shown in the figures should not be viewed as limiting. It should be understood that other implementations can include more or less of each element shown in a given figure. Further, some of the illustrated elements can be combined or omitted. Yet further, an example implementation can include elements that are not illustrated in the figures.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

1. A method comprising:
receiving, at a computing system from one or more environment state sensors, an indication of a particular environment state of an area;
while the one or more environment state sensors indicate that the area is in the particular environment state, receiving, at the computing system from a first sensor operating separate from the one or more environment state sensors, sensor data indicative of an aspect of the area;
while the area is in the particular environment state, receiving, at the computing system from a plurality of additional sensors, sensor data indicative of the aspect of the area;
performing a comparison between the set of sensor data received from the first sensor and a compilation of the sensor data received from the plurality of additional sensors;
based on the comparison, determining, by the computing system, an accuracy metric indicating an accuracy of the first sensor when the first sensor operates in the area while the area is in the particular environment state; and
based on the determined accuracy metric indicating the accuracy of the first sensor when the first sensor operates in the area while the area is in the particular environment state, causing, by the computing system, a system in the area to modify one or more aspects of the area such that the area changes from the particular environment state to a new environment state.

2. The method of claim 1, wherein the one or more environment state sensors comprise a thermometer, and
wherein the indication of the particular environment state of the area includes a current temperature of the area.

3. The method of claim 2, wherein the one or more environment state sensors indicate that the area is in the particular environment state that comprises a temperature above a predefined temperature; and
wherein while the one or more environment state sensors indicate that the area is in the particular environment state, receiving, at the computing system from the first sensor, sensor data indicative of the aspect of the area comprises:
receiving sensor data indicating a location of an object in the area from a thermal sensor.

4. The method of claim 3, wherein while the area is in the particular environment state, receiving, at the computing system from the plurality of additional sensors, sensor data indicative of the aspect of the area comprises:
receiving sensor data indicating the location of the object in the area from a plurality of cameras; and
wherein performing the comparison between the set of sensor data received from the first sensor and the compilation of the sensor data received from the plurality of additional sensors comprises:
comparing the sensor data indicating the location of the object in the area received from the thermal sensor with the sensor data indicating the location of the object in the area received from the plurality of cameras.

5. The method of claim 1, wherein the one or more environment state sensors comprise an ambient light sensor, and
wherein the indication of the particular environment state of the area includes information indicating an ambient light level of the area.

6. The method of claim 1, wherein the compilation of the sensor data received from the plurality of additional sensors corresponds to a mathematical average based on the sensor data received from the plurality of additional sensors.

7. The method of claim 1, further comprising:
providing, by a computing system via a display interface, a graphical heat map that indicates a coverage accuracy of sensors in one or more areas based on a plurality of determined accuracy metrics associated with a plurality of sensors in the one or more areas; and
modifying, by the computing system, the graphical heat map to further include information based on the determined accuracy metric of the first sensor when the first sensor operates in the area while the area in the particular environment state.

8. The method of claim 7, further comprising:
modifying, by the computing system, the graphical heat map to show changes in coverage accuracies of sensors in the plurality of areas based on a time of day.

9. The method of claim 1, further comprising:
based on the determined accuracy metric of the first sensor when the first sensor operates in the area while the area is in the particular environment state, providing instructions to a robotic device to travel to the area and provide additional sensor information corresponding to the area to the computing system via a wireless connection with the computing system.

10. The method of claim 1, wherein the first sensor is positioned on a robotic device; and further comprising:
determining the plurality of additional sensors based on a location of the robotic device, wherein the plurality of additional sensors are configured to measure a given area that includes the location of the robotic device.

11. The method of claim 1, wherein the accuracy metric of the first sensor when the first sensor operates in the area is in the particular environment state depicts the accuracy of the first sensor relative to operation of the first sensor in the area while the area is in a plurality of different environment states.

12. A computing system, comprising:
one or more processors; and
a non-transitory computer-readable medium, configured to store instructions, that when executed by the one or more processors, cause the computing system to perform functions comprising:
receiving, from one or more environment state sensors, an indication of a particular environment state of an area;
while the one or more environment state sensors indicate that the area is in the particular environment state, receiving, from a first sensor operating separate from the one or more environment state sensors, sensor data indicative of an aspect of the area;
while the area is in the particular environment state, receiving, from a plurality of additional sensors, sensor data indicative of the aspect of the area;
performing a comparison between the set of sensor data received from the first sensor and a compilation of the sensor data received from the plurality of additional sensors;
based on the comparison, determining an accuracy metric indicating an accuracy of the first sensor when the first sensor operates in the area while the area is in the particular environment state; and
based on the determined accuracy metric indicating the accuracy of the first sensor when the first sensor operates in the area while the area is in the particular environment state, causing a system in the area to modify one or more aspects of the area such that the area changes from the particular environment state to a new environment state.

13. The system of claim 12, wherein the first sensor is a range-based sensor and wherein the plurality of additional sensors includes a plurality of cameras.

14. (canceled)

15. The system of claim 12, wherein the particular environment state of the area comprises a level of ambient light above a predetermined level of ambient light; and
wherein causing the system in the area to modify one or more aspects of the area such that the area changes from the particular environment state to the new environment state comprises:
causing the system in the area to close one or more window coverings in the area to decrease the level of ambient light in the area. instructions, that when executed by one or more processors, cause a computing system to perform functions comprising:
receiving, from one or more environment state sensors, an indication of a particular environment state of an area;
while the one or more environment state sensors indicate that the area is in the particular environment state, receiving, from a first sensor operating separate from the one or more environment state sensors, sensor data indicative of an aspect of the area;
while the area is in the particular environment state, receiving, from a plurality of additional sensors, sensor data indicative of the aspect of the area;
performing a comparison between the set of sensor data received from the first sensor and a compilation of the sensor data received from the plurality of additional sensors;
based on the comparison, determining an accuracy metric indicating an accuracy of the first sensor when the first sensor operates in the area while the area is in the particular environment state; and
based on the determined accuracy metric indicating the accuracy of the first sensor when the first sensor operates in the area while the area is in the particular environment state, causing a system in the area to modify one or more aspects of the area such that the area changes from the particular environment state to a new environment state.

17. The non-transitory computer-readable medium of claim 16, further comprising:
determining one or more spatial patterns indicative of coverage accuracies of sensors in one or more areas based on the determined accuracy metric of the first sensor when the first sensor operates in the area while the area is in the particular environment state and a plurality of other determined accuracy metrics indicative of operation of a plurality of sensors including the first sensor when the plurality of sensors operate in the area while the area is in a plurality of different environment states.

18. The non-transitory computer-readable medium of claim 16, wherein while the one or more environment state sensors indicate that the area is in the particular environment state, receiving, from the first sensor, sensor data indicative of an aspect of the area comprises:
receiving sensor data indicating a location of a user in the area from a thermal sensor while a humidity sensor in the one or more environment state sensors indicates that the particular environment state of the area includes a humidity level above a predefined humidity level.

19. (canceled)

20. The non-transitory computer-readable medium of claim 15, further comprising:
based on the determined accuracy metric and a plurality of other determined accuracy metrics, determining one or more predicted coverage accuracies of a plurality of sensors in the area at a plurality of future time periods.

21. The method of claim 1, wherein causing the system in the area to modify one or more aspects of the area such that the area changes from the particular environment state to the new environment state comprises:
causing a heating and cooling system to adjust a temperature of the area such that the area changes from the particular environment state to a given environment state with a different temperature.

22. The method of claim 1, wherein causing the system in the area to modify one or more aspects of the area such that the area changes from the particular environment state to the new environment state comprises:
causing the system in the area to modify one or more aspects such that the area changes from the particular environment state to a given environment state that increases an accuracy of the first sensor.
